(19) United States
(12) Patent Application Publication
(10) Pub. No.: US 2013/0238911 A1
(43) Pub. Date: Sep. 12, 2013

(54) POWER SUPPLY DEVICE FOR COMPUTER SYSTEMS AND COMPUTER SYSTEM USING THE POWER SUPPLY DEVICE

(71) Applicants: BO TIAN, Shenzhen City (CN); KANG WU, Shenzhen City (CN)

(72) Inventors: BO TIAN, Shenzhen City (CN); KANG WU, Shenzhen City (CN)

(21) Appl. No.: 13/648,264

(22) Filed: Oct. 9, 2012

(30) Foreign Application Priority Data
Mar. 7, 2012 (CN) 201210057642.6

(51) Int. Cl. G06F 1/26

(52) U.S. Cl. 713/300

(57) ABSTRACT

A power supply device for a computer system with a plurality of servers includes a power supply, a switch circuit, and a control unit. Each of the plurality of servers are electrically connected to the power supply via the switch circuit. The control unit is electrically connected to the power supply, the switch circuit, and each of the plurality of servers. Each of the plurality of servers is configured to send a selection signal to the control unit. Upon receiving the selection signal from one or more of the plurality of servers, the control unit turns on the power supply and controls the switch circuit to electrically connect the power supply with the one or more of the plurality of servers sending the selection signal.

### BACKGROUND

1. Technical Field

The present disclosure relates to power supply devices, and particularly to a power supply device for computer systems with a plurality of servers and a computer system using the same.

2. Description of Related Art

A computer system can employ a plurality of servers to enhance data processing capability. For example, a common four-in-one server system includes four servers, and the four servers share one hard disk backboard that is electrically connected to hard disk drives. In use, each of the four servers can control a plurality of hard disk drives via the hard disk backboard, so that the four-in-one server system achieves high data processing capability.

In a computer system employing a plurality of servers, the servers generally require to work independently from each other to prevent failures of any one of the servers from adversely affecting the other servers. Therefore, each of the servers may need a power supply that is independent from power supplies of the other servers. However, equipping an exclusive power supply for each of the servers may be costly and complicate a hardware structure of the computer system.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a computer system, according to an exemplary embodiment.

FIG. 2 is a circuit diagram of the computer system shown in FIG. 1.

### DETAILED DESCRIPTION

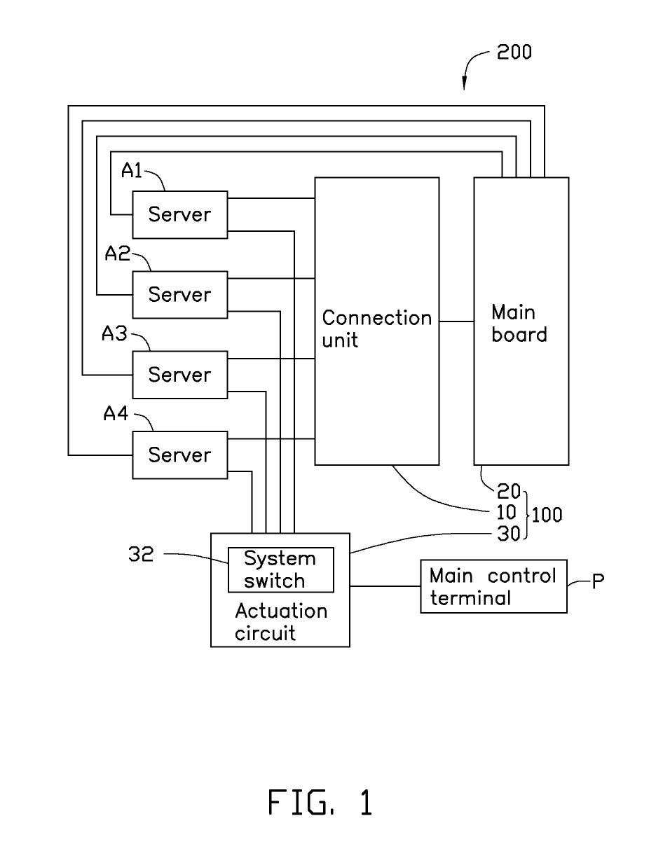

FIG. 1 is a block diagram of a computer system 200, according to an exemplary embodiment. In one embodiment, the computer system 200 is a four-in-one computer system, and includes four servers A1, A2, A3, and A4, and a power supply device 100. The power supply device 100 can selectively provide electrical power to one or more of the servers A1-A4.

The power supply device 100 includes a connection unit 10, a main board 20, and an actuation circuit 30. The connection unit 10 can be a typical bridging board. The servers A1-A4 are all electrically connected to the main board 20 via the connection unit 10. Furthermore, the servers A1-A4 are all electrically connected to the actuation circuit 30.

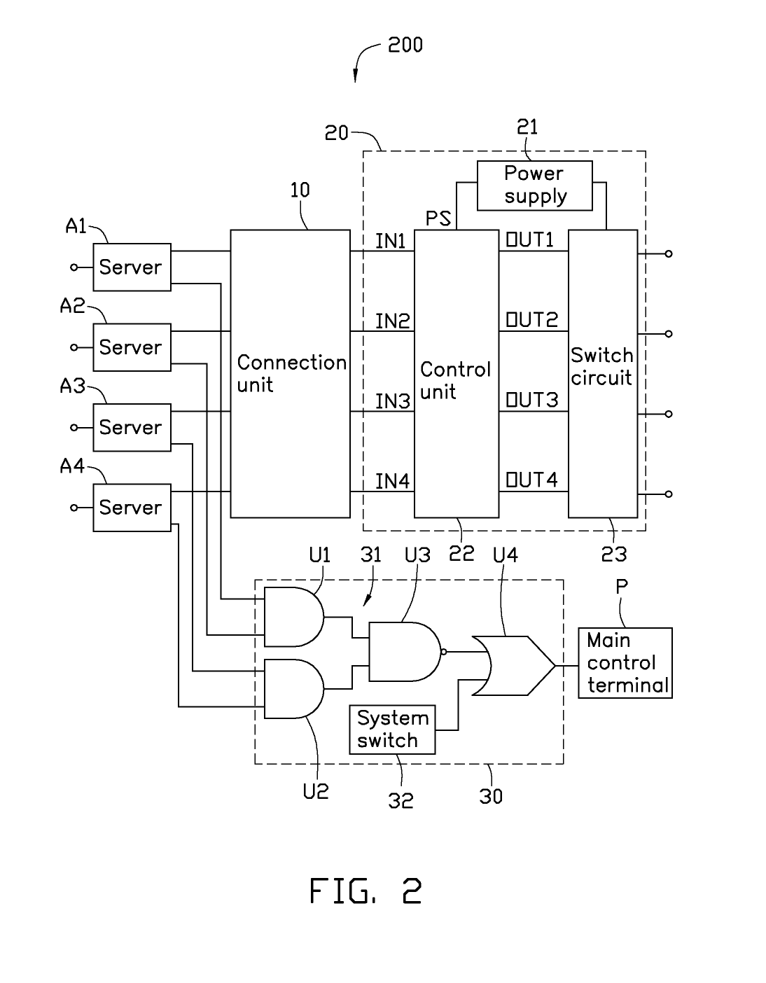

The main board 20 includes a power supply 21, a control unit 22, and a switch circuit 23. The power supply 21 can be a battery, or an electrical connector configured for electrically connecting with a wall socket. The control unit 22 can be an integrated circuit (IC), such as an IDTQS3125QG8 circuit. Also referring to FIG. 2, the control unit 22 includes four input pins IN1, IN2, IN3, and IN4 corresponding to the servers A1-A4, and four output pins OUT1, OUT2, OUT3, and OUT4 corresponding to the input pins IN1-IN4. The servers A1-A4 are respectively electrically connected to the input pins IN1-IN4 via the connection unit 10. Each of the servers A1-A4 can generate a selection signal, and transmit the selection signal to the control unit 22 via the input pin IN1/IN2/IN3/IN4 corresponding to the server A1/A2/A3/A4. Upon receiving the selection signal from one or more of the input pins IN1-IN4, the control unit 22 can generate a switching signal on and send the switching signal via the output pin OUT1/OUT2/OUT3/OUT4 corresponding to the input pin IN1/IN2/IN3/IN4 receiving the selection signal. The control unit 22 further includes a power supply pin PS electrically connected to the power supply 21. The control unit 22 can turn the power supply 21 on and off by sending a power signal to the power supply 21 via the power supply pin PS.

The switch circuit 23 can be a strobe circuit or a multiplex switch. The servers A1-A4 are all electrically connected to the power supply 21 via the switch circuit 23, and the output pins OUT1-OUT4 are all electrically connected to the switch circuit 23. When one or more of the output pins OUT1-OUT4 sends the switching signal to the switch circuit 23, the switch circuit 23 electrically connects the server A1/A2/A3/A4 corresponding to the output pin OUT1/OUT2/OUT3/OUT4 sending the switching signal with the power supply 21. Thus, the power supply 21 can supply electrical power to the server A1/A2/A3/A4.

When one or more of the servers A1-A4 requires power, the server A1/A2/A3/A4 generates the selection signal. Power for generating the selection signal can be provided by a typical backup power supply (not shown) integrated within the server A1/A2/A3/A4 or the main board 20. The selection signal can be automatically generated by a typical integrated baseboard management controller (iBMC) of the server A1/A2/A3/A4, and can also be manually generated by manual operations applied to the server A1/A2/A3/A4.

The selection signal generated by the server A1/A2/A3/A4 requiring power is transmitted to the control unit 22 via the input pin IN1/IN2/IN3/IN4 corresponding to the server A1/A2/A3/A4 requiring power. Upon receiving the selection signal, the control unit 22 turns on the power supply 21, and generates a switching signal on the output pin OUT1/OUT2/OUT3/OUT4 corresponding to the input pin IN1/IN2/IN3/IN4 receiving the selection signal, and sends the switching signal to the switching circuit 23. Upon receiving the switching signal, the switching circuit 23 electrically connects the server A1/A2/A3/A4 requiring power with the power supply 21. Thus, the power supply 21 can supply electrical power to the server A1/A2/A3/A4 requiring power.

According to the above-described method, when receiving the selection signal from one or more of the servers A1-A4, the control unit 22 turns on the power supply 21. At the same time, only the server A1/A2/A3/A4 sending the selection signal is electrically connected to the power supply 21 via the switch circuit 23. In this way, the power supply device 100 is capable of selectively providing electrical power to one or more of the servers A1-A4, and power supply of each of the servers A1-A4 is independent from that of the other of the servers A1-A4. By means of using the power supply device 100, the computer system 200 does not need to equip an exclusive power supply for each of the servers S1-S4. Therefore, the computer system 200 costs less, and a hardware structure of the computer system 200 is simplified.

When the servers A1-A4 are electrically connected to the main board 20, they generally need to spend a predetermined actuation time in achieving normal working statuses. During the actuation time, if instructions are input to the computer system 200, failures may occur in the system device 200. Therefore, the actuation circuit 30 is configured to prevent these failures.

The computer system 200 further includes a main control terminal P. Predetermined electronic signals input to the main control terminal P can control the computer system 200 to be turned on and off. In this embodiment, the computer system 200 is turned on when the main control terminal P receives a predetermined logic 0 signal (e.g., a relatively lower voltage), and is turned off when the main control terminal P receives a predetermined logic 1 signal (e.g., a relatively higher voltage). The actuation circuit 30 includes a logic circuit 31 and a system switch 32. The servers A1-A4 and the system switch 32 are all electrically connected to the logic circuit 31, and the logic circuit 31 is electrically connected to the main control terminal P. All of the servers A1-A4 and the system switch 32 can send status signals to the logic circuit 31, and the logic circuit 31 logically calculates the status signals. The calculation result is used as a main control signal and transmitted to the main control terminal P to turn on and off the computer system 200.

The logic circuit 31 includes two AND gates U1 and U2, an NAND gate U3, and an OR gate U4. Two of the servers A1-A4 (e.g., the servers A1 and A2) are respectively electrically connected to two input ends of the AND gate U1, and the other two of the servers A1-A4 (e.g., the servers A3 and A4) are respectively electrically connected to two input ends of the AND gate U2. Output ends of the two AND gates U1 and U2 are respectively electrically connected to two input ends of the NAND gate U3. An output end of the NAND gate U3 and the system logic 32 are respectively electrically connected to two input ends of the OR gate U4, and an output end of the OR gate U4 is electrically connected to the main control terminal P.

In this embodiment, any valid operation applied to the system switch 32 generates a logic 0 system signal transmitted to the input end of the OR gate U4 electrically connected to the system switch 32. Each of the servers A1-A4 is set to generate a logic 0 status signal when it does not achieve a normal working status, and generate a logic 1 status signal when it has achieved the normal working status. Furthermore, if one or more of the servers A1-A4 is not electrically connected to the logic circuit 31, the input end of the AND gate U1/U2 which is not electrically connected to any sever is set to generate a logic 1 signal.

In use, when at least one of the servers A1-A4 is electrically connected to the logic circuit 31 but does not achieve the normal working status, at least one input end of the AND gate U1 or U2 receives a logic 0 status signal from the at least one of the servers A1-A4, which causes the NAND gate U3 to input a logic 1 signal to the OR gate U4. Thus, no matter what system signal is received from the system switch 32 by the OR gate U4, the OR gate U4 outputs a logic 1 signal to the main control terminal P. The computer system 200 is maintained to be turned off due to the logic 1 signal received by the main control terminal P. In this way, although the system switch 32 is operated, the computer system 200 is not turned on, and the aforementioned possible failures are avoided.

When at least one of the servers A1-A4 is electrically connected to the logic circuit 31, and each of the servers A1-A4 electrically connected to the logic circuit 31 has achieved the normal working status, all input ends of the AND gates U1 and U2 receive logic 1 signals. Thus, both the AND gates U1 and U2 output logic 1 signals, and the NAND gate U3 outputs a logic 0 signal to the OR gate U4. If the system switch 32 is operated now, both the two input ends of the OR gate U4 receive logic 0 signals, and the OR gate U4 outputs a logic 0 signal to the main control terminal P to turn on the computer system 200.

In another embodiment, the switch circuit 23 includes a plurality of (e.g., four) single-way switches (not shown) corresponding to the servers A1-A4 and the output pins OUT1-OUT4. Each of the single-way switches is electrically connected between the server A1/A2/A3/A4 corresponding to the single-way switch and the power supply 21, and is further electrically connected to the output pin OUT1/OUT2/OUT3/OUT4 corresponding to the single-way switch. The control unit 22 can control one or more of the single-way switches to electrically connect the server A1/A2/A3/A4 corresponding to the controlled single-way switch to the power supply 21 via the output pin OUT1/OUT2/OUT3/OUT4 corresponding to the controlled single-way switch, such that the power supply 21 can supply electrical power to the server A1/A2/A3/A4 corresponding to the controlled single-way switch.

In other embodiments, the control unit 22 can include more than four input pins and output pins corresponding to more than four servers. Each of the additional servers is electrically connected to the power supply 21 via the switch circuit 23, and is further electrically connected to the control unit 22 via the corresponding input pin and output pin. Correspondingly, the logic circuit 31 can include more AND gates, and each of the additional servers is electrically connected to the NAND gate U3 via an AND gate. Methods for using these embodiments are similar to the aforementioned method for using the power supply device 100.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device for a computer system that comprises a plurality of servers, comprising:
a power supply;
a switch circuit, each of the plurality of servers electrically connected to the power supply via the switch circuit; and
a control unit electrically connected to the power supply, the switch circuit, and each of the plurality of servers, and
wherein each of the plurality of servers is configured to send a selection signal to the control unit; and upon receiving the selection signal from one or more of the plurality of servers, the control unit turns on the power supply and controls the switch circuit to electrically connect the power supply with the one or more of the plurality of servers sending the selection signal.

2. The power supply device of claim 1, wherein the control unit includes a plurality of input pins and a plurality of output pins corresponding to the plurality of servers, the plurality of servers are respectively electrically connected to the plurality of input pins, and each of the plurality of output pins is electrically connected to the switch circuit.

3. The power supply device of claim 2, wherein the selection signal sent from each of the plurality of servers is input to the control unit via the input pin corresponding to the server, the control unit generates a switching signal on the output pin corresponding to the server upon receiving the selection signal, and the switch circuit electrically connects the power supply with the server upon receiving the switching signal.

4. The power supply device of claim 2, further comprising a connection circuit; wherein the connection circuit is a bridging board, and the servers are respectively electrically connected to the input pins via the connection unit.

5. The power supply device of claim 1, further comprising an actuation circuit; wherein the actuation circuit includes a logic circuit electrically connected to a main control terminal of the computer system and a system switch electrically connected to the logic circuit; each of the servers is electrically connected to the logic circuit and generates a status signal transmitted to the logic circuit, and the system switch generates a system signal transmitted to the logic circuit; and the actuation circuit logically calculates the status signals and the system signal and transmits the calculation result to the main control terminal to turn on and off the computer system.

6. The power supply device of claim 5, wherein the logic circuit includes a plurality of AND gates, an NAND gate, and an OR gate; the servers are respectively electrically connected to input ends of the AND gates and input the status signals to the input ends of the AND gates; output ends of the AND gates are all electrically connected to input ends of the NAND gate; an output end of the NAND gate and the system switch are electrically connected to input ends of the OR gate; and an output end of the OR gate is electrically connected to the main control terminal.

7. A computer system, comprising:
a plurality of servers; and
a power supply device for the plurality of servers, including:
a power supply;
a switch circuit, each of the plurality of servers electrically connected to the power supply via the switch circuit; and
a control unit electrically connected to the power supply, the switch circuit, and each of the plurality of servers, and
wherein each of the plurality of servers is configured to send a selection signal to the control unit; and upon receiving the selection signal from one or more of the plurality of servers, the control unit turns on the power supply and controls the switch circuit to electrically connect the power supply with the one or more of the plurality of servers sending the selection signal.

8. The computer system of claim 7, wherein the control unit includes a plurality of input pins and a plurality of output pins corresponding to the plurality of servers, the plurality of servers are respectively electrically connected to the plurality of input pins, and each of the plurality of output pins is electrically connected to the switch circuit.

9. The computer system of claim 8, wherein the selection signal sent from each of the plurality of servers is input to the control unit via the input pin corresponding to the server, the control unit generates a switching signal on the output pin corresponding to the server upon receiving the selection signal, and the switch circuit electrically connects the power supply with the server upon receiving the switching signal.

10. The computer system of claim 8, wherein the power supply device further includes a connection circuit, the connection circuit is a bridging board, and the servers are respectively electrically connected to the input pins via the connection unit.

11. The computer system of claim 7, further comprising a main control terminal; wherein the power supply device further includes an actuation circuit, and the actuation circuit includes a logic circuit electrically connected to the main control terminal and a system switch electrically connected to the logic circuit; each of the servers is electrically connected to the logic circuit and generates a status signal transmitted to the logic circuit, and the system switch generates a system signal transmitted to the logic circuit; and the actuation circuit logically calculates the status signals and the system signal and transmits the calculation result to the main control terminal to turn on and off the computer system.

12. The computer system of claim 11, wherein the logic circuit includes a plurality of AND gates, an NAND gate, and an OR gate; the servers are respectively electrically connected to input ends of the AND gates and input the status signals to the input ends of the AND gates; output ends of the AND gates are all electrically connected to input ends of the NAND gate; an output end of the NAND gate and the system switch are electrically connected to input ends of the OR gate; and an output end of the OR gate is electrically connected to the main control terminal.

13. The computer system of claim 12, wherein the computer system is turned on when the main control terminal receives a logic 0 signal, and is turned off when the main control terminal receives a logic 1 signal.

14. The computer system of claim 13, wherein each of the servers generates a logic 0 status signal when it does not achieve a normal working status, and generates a logic 1 status signal when it achieves the normal working status.

15. The computer system of claim 14, wherein any input end of the AND gates generates a logic 1 status signal when it is not electrically connected to any of the plurality of severs.

16. The computer system of claim 15, wherein the system signal is a logic 0 signal.
